(19) United States
(12) Patent Application Publication
(10) Pub. No.: US 2002/0127368 A1
(43) Pub. Date: Sep. 12, 2002

(54) Decoration of conservatories

(75) Inventor: Christopher Richardson, Lancashire (GB)

Correspondence Address: Wood, Phillips, Katz, Clark & Mortimer, Citicorp Center, Suite 3800, 500 West Madison Street, Chicago, CA, 60661-2511, US

(73) Assignee: Ultraframe (UK) Limited.

(21) Appl. No.: 10/094,677

(22) Filed: Mar. 11, 2002

(30) Foreign Application Priority Data
Mar. 9, 2001 (GB) 0105888.2

(51) Int. Cl. B32B 3/06

(52) U.S. Cl. 428/99; 428/100

(57) ABSTRACT

In order to decorate a conservatory made from aluminium structural members and plastics covers and cappings, such covers and/or cappings on eaves beams or windowsills, for example, are arranged to receive decorative inserts.

This invention concerns decoration of conservatories and buildings.

PVCu conservatories are generally made from aluminium structural members covered with PVCu cappings that are usually white but can be provided with a wood grain effect. Timber cladding itself may be used.

In general, once the internal cappings have been applied to the structural members, they remain in place for the lifetime of the conservatory, or until they need to be replaced due to damage. These cappings are not suitable for applying a decoration and so any decorative enhancement of a conservatory is limited to lead lighting in windows and to placement of decorative items, such as plants.

Furthermore, if decoration were to be added to a conservatory, it would be difficult to extend any scheme of decoration into the structure adjoining the conservatory. For example, a conservatory attached to a living room of a house may look out of place or disjointed if decorated in a different scheme to the living room.

An object of this invention is to provide for the decorative enhancement of conservatories and adjoining structures.

According to the invention, it is proposed that decorative strips or profiles be attachable to conservatory components and buildings.

The strips or profiles may be attachable to any conservatory components, either internal or external, but it is preferable that the strips or profiles are attachable to internal plastics components thereof, especially components that cover aluminium structural members. The structural member of the conservatory may be, for example, an eaves beam, a cill, a roof ridge, a corner post, a mullion or a window frame member. Attachment may be directly to an aluminium structural member but will more often be to a plastics covering component for an aluminium structural member, such as a capping or a fascia panel. When attachment of the decorative strip is directly to an aluminium structural member, it is preferred that the structural member include a thermal break.

Where the decorative scheme is extended into an adjoining structure, means may be provided for attaching the same decorative strips used in the conservatory to surfaces of the adjoining structure. Preferably, the decorative strips may be attached to walls, skirting boards, window frames, dado rails or any other suitable surface.

Where suitable surfaces do not exist, the present invention may additionally provide means for securing the decorative strips to surfaces, such as profiled extrusions that may be nailed, clipped or adhered to the surface in question. The decorative strips or profiles may be attached to conservatory components or other building surfaces by any suitable means. These may include direct attachment, such as by means of adhesive, Velcro, magnetism and the like, and keyed attachment such as slots, rebates and the like. For example, magnetic strips ran be adhered to one component and ferromagnetic material be provided on or incorporated into the other component.

In one preferred embodiment of the invention, a plastics component, such as a fascia panel or dado rail, has a rebated channel formed thereon into which a decorative strip or profile may be slid or, by having a top rebate deeper than a bottom rebate, the decorative strip or profile can be pushed up into the top rebate to clear the bottom rebate, so that it can drop into the bottom rebate.

In another preferred embodiment of the invention, a plastics component and the decorative strip or profile may have mutually engageable formations thereon, in order to retain the decorative strip or profile on the plastics component. More preferably still, one of the plastics component and the decorative strip or profile provides at least one hooked member and the other has a corresponding number of co-operating slot/slots or the like thereon, which locate over the hooked members, thereby releasably retaining the decorative strip or profile on the plastics component. More preferably still, the plastics component has at least one, but more preferably two, vertically spaced hooked members thereon, and the decorative strip or profile has a corresponding number of co-operating slots thereon. To provide an alternative means of attachment, the decorative strip or profile may have a raised rim at or near each longitudinal edge thereof, such that it may be retained on a plastics component by way of being snap-fitted past top and bottom ribs of the plastics component and held therein.

Alternatively, the decorative strip or profile may be rebated to form a channel having edges allowing the decorative strip or profile to be snap-fitted over edges of a plastics component.

When the plastics component is a fascia panel, the means of attachment of the fascia to the structural member is preferably by way of one or more fir-tree type ribs of one component push fitted onto slots of the other component. The ribs are preferably on the structural member. According to another preferred embodiment of the invention, there is provided a decorative strip or profile attached to a structural member of a conservatory. The structural member may be an eaves beam having at least one, but more preferably two vertically spaced hooked members thereon, and the decorative strip or profile has a corresponding number of co-operating slots, whereby the decorative strip or profile may be retained on the eaves beam.

When the decorative strips are to be used in a building and suitable attachment locations cannot be easily found, a mounting component may be used. The mounting component is preferably a plastics extrusion having formations thereon for retaining the decorative strip. On the reverse side of the mounting component, there may be features such as webs, suitable for gluing the mounting component to a surface of the building Alternatively, resiliently deformable clips may be provided on the reverse side of the mounting component that engage with resiliently deformable clips of a further backing component.

It is preferred feature of the present invention that a variety of mounting components may be used for different situations, for example as dado rails, skirting boards, architraves, etc.

In practice, the backing component is preferably cut to length and affixed to the building surface by means of screws, nails or adhesive. Preferably also, the mounting component cut to length and then push-fitted onto the backing member such that the resiliently deformable clips mutually engage. Finally, the decorative strip may be cut to a desired length and be retained by the mounting component.

It is preferred that decorative strips or profiles used in the invention have three dimensional relief thereon, for example, in the form of flowers, geometrical shapes, etc., formed by embossing. However, alternatively, the decorative effects on the strip or profile may be two dimensional in nature, the strips or profiles being decorated with paint, ink or film. It is further preferable that the decorative strips or profiles are made from plastic, wood, fabric, or any other suitable material, to give a desired effect. It is preferred that the decorative strip or profile is injection molded.

Decorative strips or profiles used in the invention may be shaped and sized in order to accommodate other items to be at least partially concealed thereby. For example, by having a decorative strip or profile in the form of a cornice molding that extends upwardly and inwardly from an eaves beam, space may be provided for concealing window blinds or lighting components.

It is preferred that the decorative strips or profiles are reversible in nature, having different decorative effects on opposing faces thereof. In this way, if a user wants to change the decoration on the structural member, then he or she may simply remove the decorative strip or profile from the structural member, reverse it to expose the decorative effects on the other side, and then replace it on the structural member.

It is preferable that, in the case where the structural component is an eaves beam, when the internal covering member is in place on the eaves beam, a part of the outer face of the fascia panel covers the head of the eaves beam. Further, it is preferred that a part of the outer face of the fascia panel covers the bottom part of the eaves beam, when the internal covering member is in place on the eaves beam.

Preferably, a number of internal covering members may be used end to end, in order to cover the length of the particular structural member, for example, eaves beam or cill, being covered.

The invention will now be further described, by way of example only, with reference to the accompanying drawings in which:

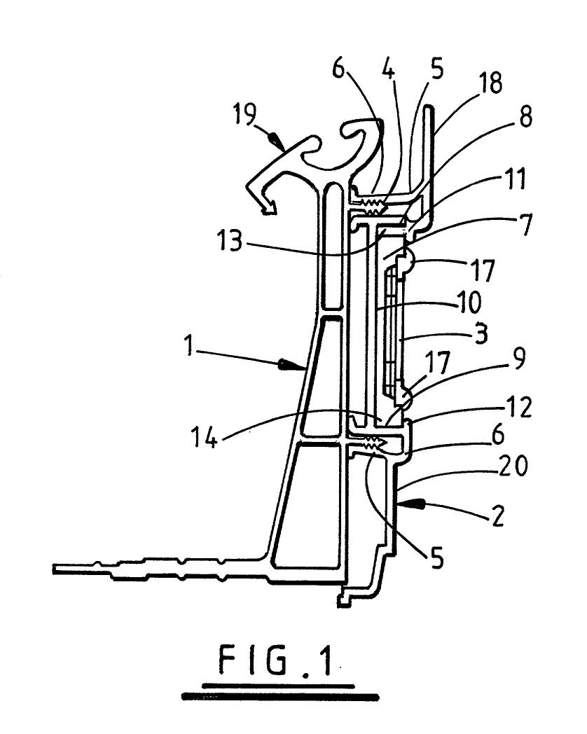

FIG. 1 is a side view of a first embodiment of a decorative covering member of the invention, in situ, attached to an eaves beam;

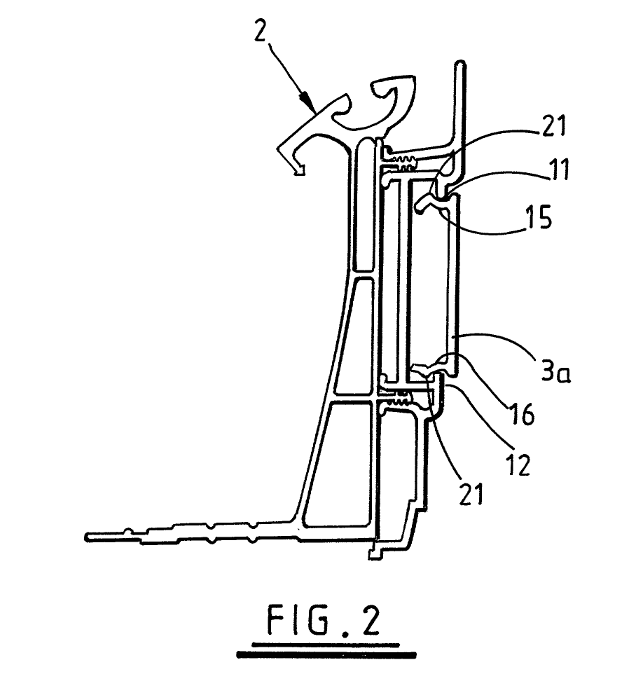

FIG. 2 is a side view of a second embodiment of a decorative covering member of the invention, in situ, attached to an eaves beam;

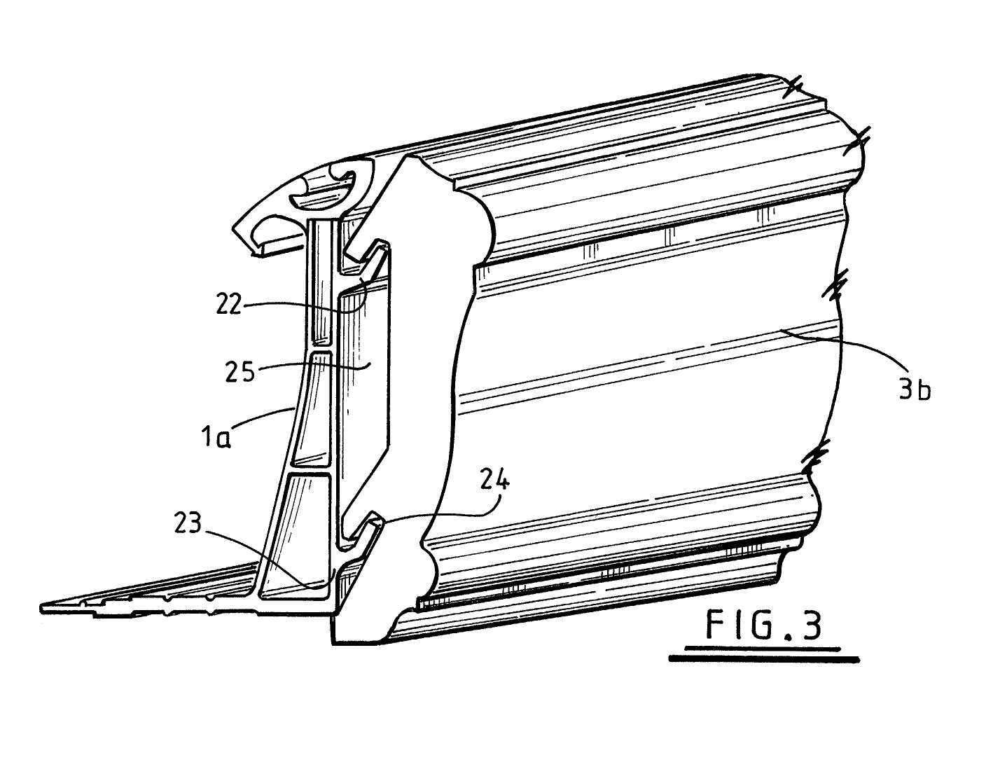

FIG. 3 is a perspective view of a decorative covering member according to a second aspect of the present invention;

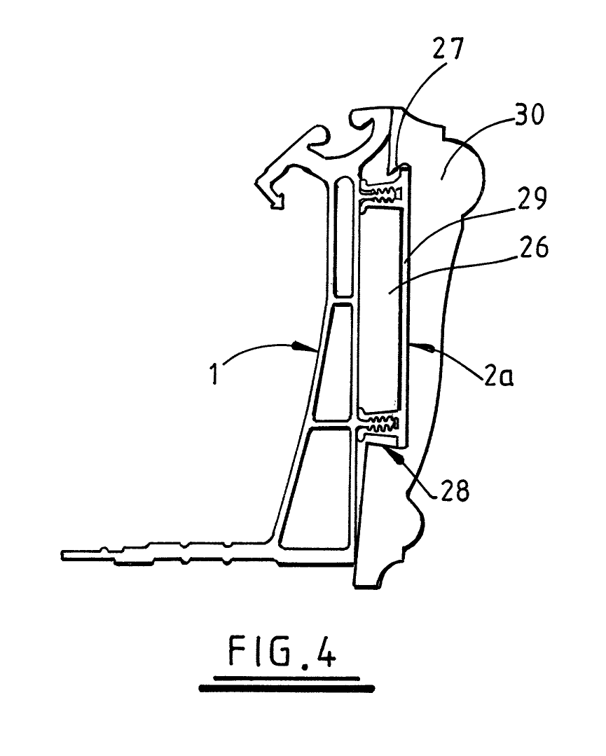

FIG. 4 is a side view of a third embodiment of a decorative covering member of the invention, in situ, attached to an eaves beam;

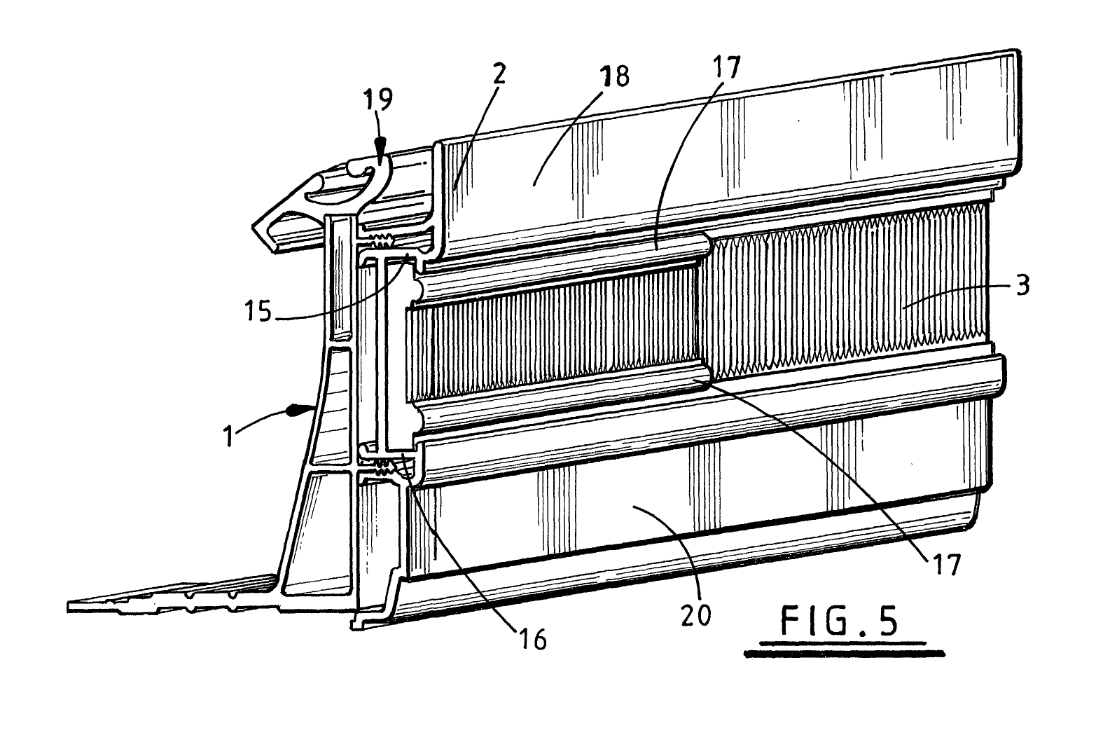

FIG. 5 is a perspective view of a first embodiment of a decorative covering member of the invention, in situ, attached to an eaves beam;

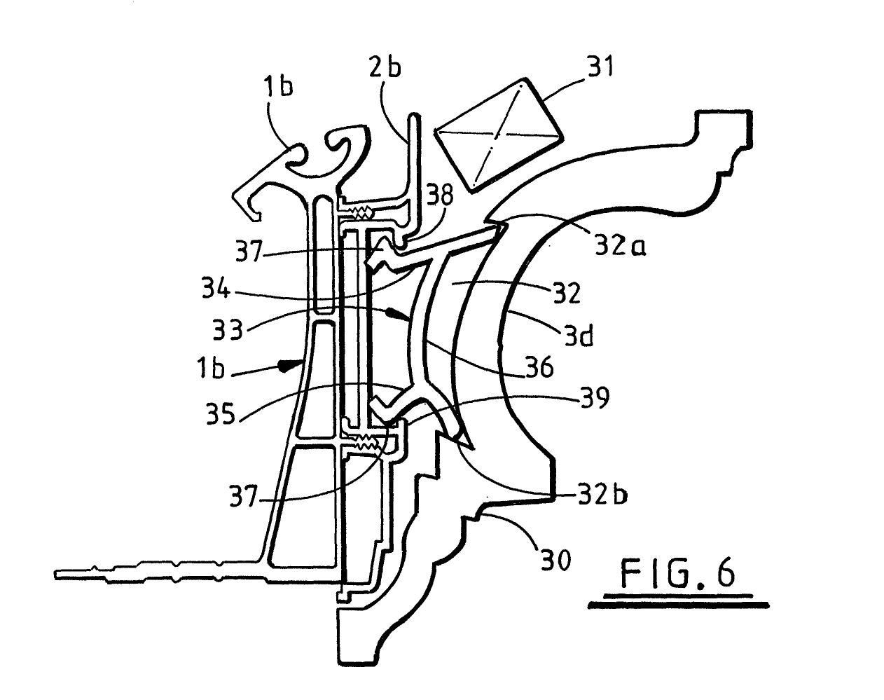

FIG. 6 shows a fourth embodiment of the invention;

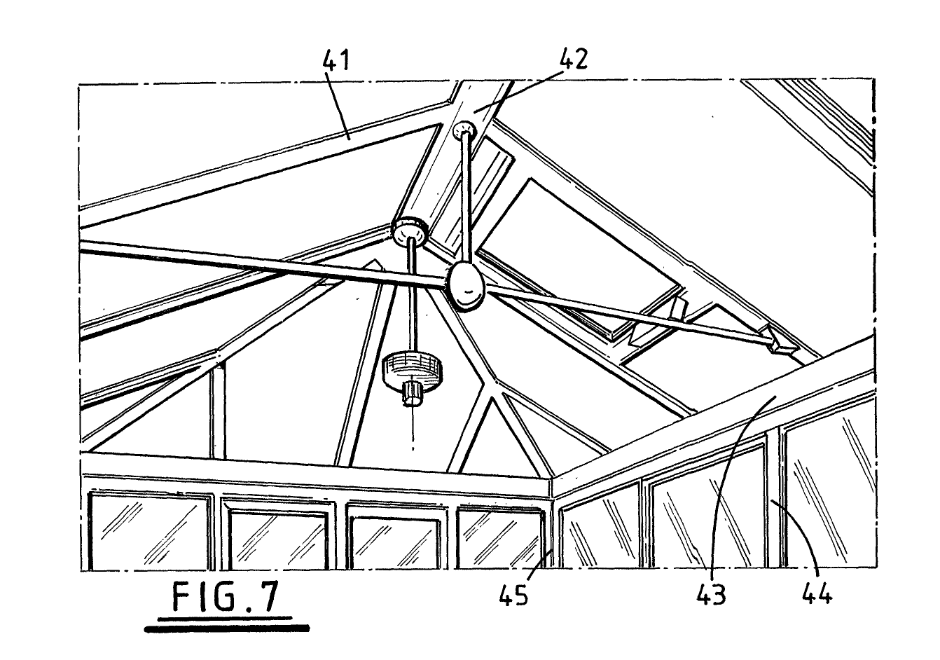

FIG. 7 shows an interior of a conservatory;

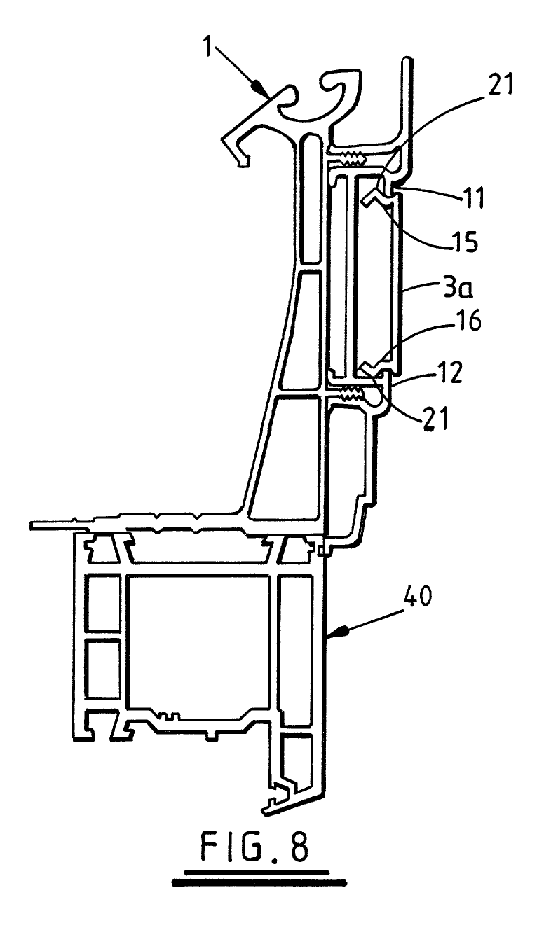

FIG. 8 shows a side view of a second embodiment of a decorative covering member of the invention, in situ, attached to an eaves beam;

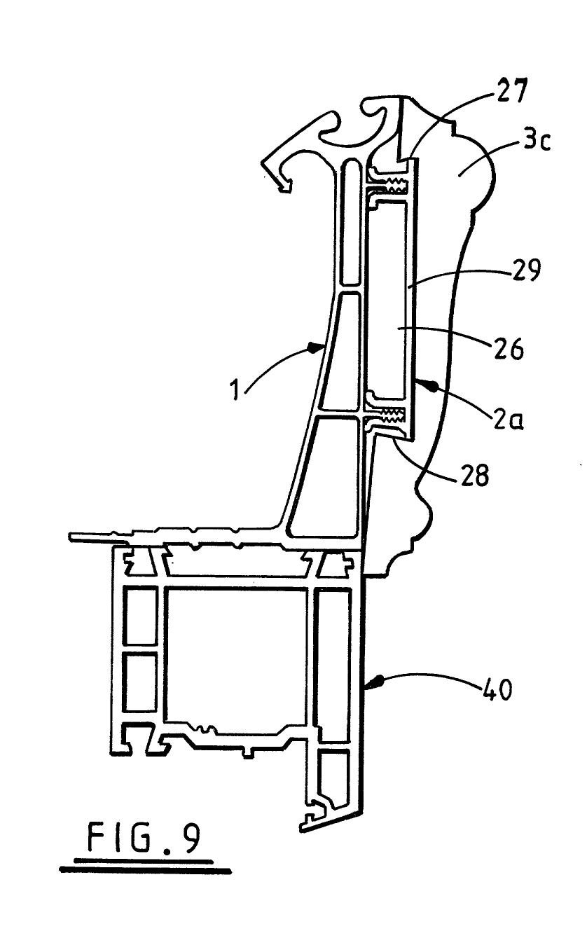

FIG. 9 shows a side view of a third embodiment of a decorative covering member of the invention, in situ, attached to an eaves beam;

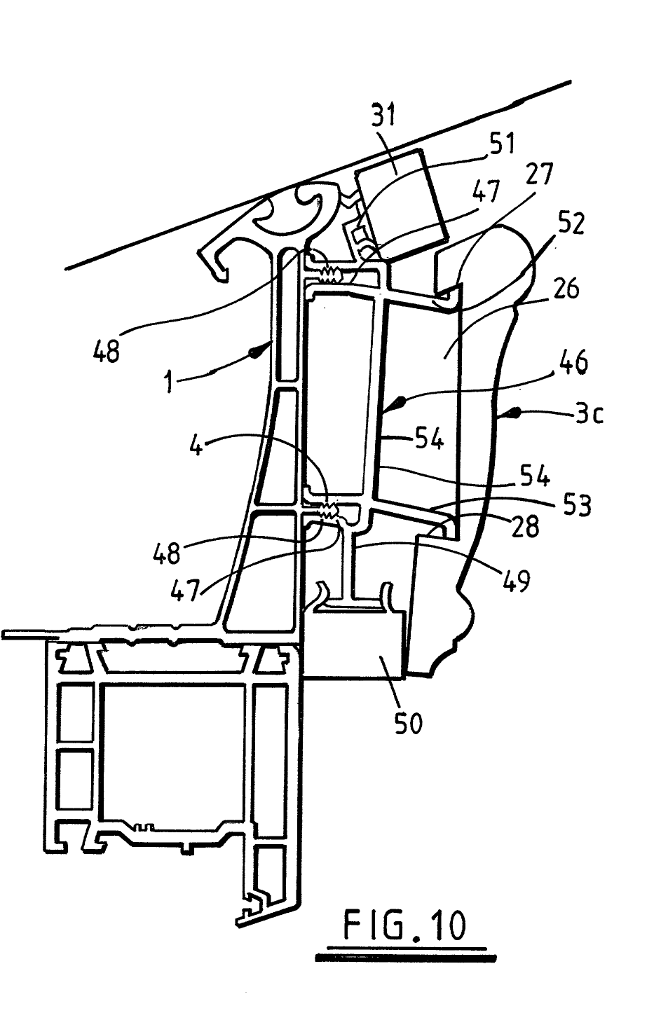

FIG. 10 shows a fifth embodiment of the invention;

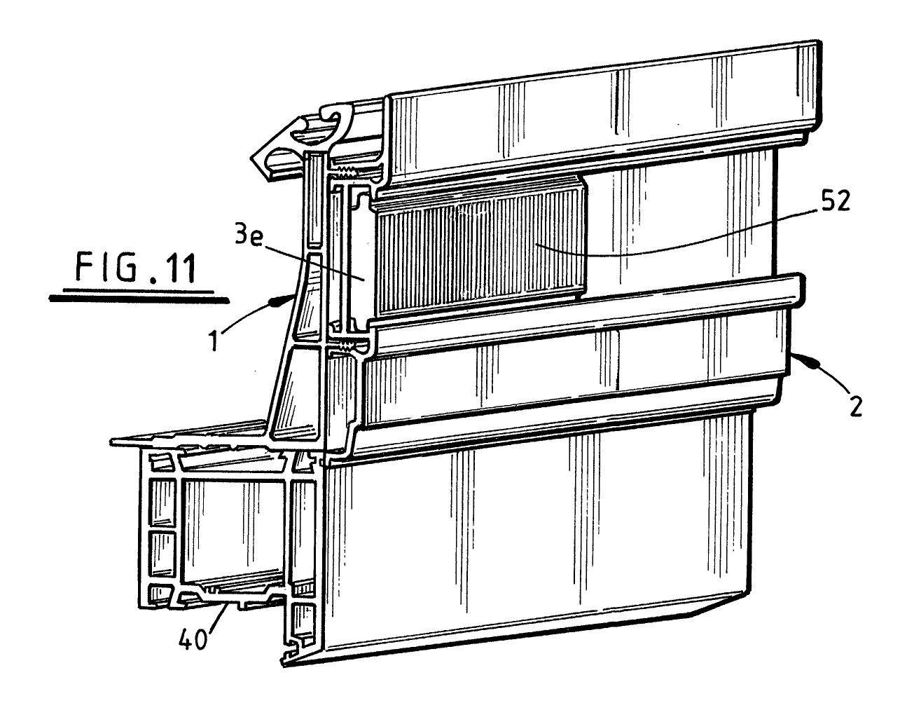

FIG. 11 is a perspective view of a sixth embodiment of a decorative covering member of the invention, in situ, attached to an eaves beam; and

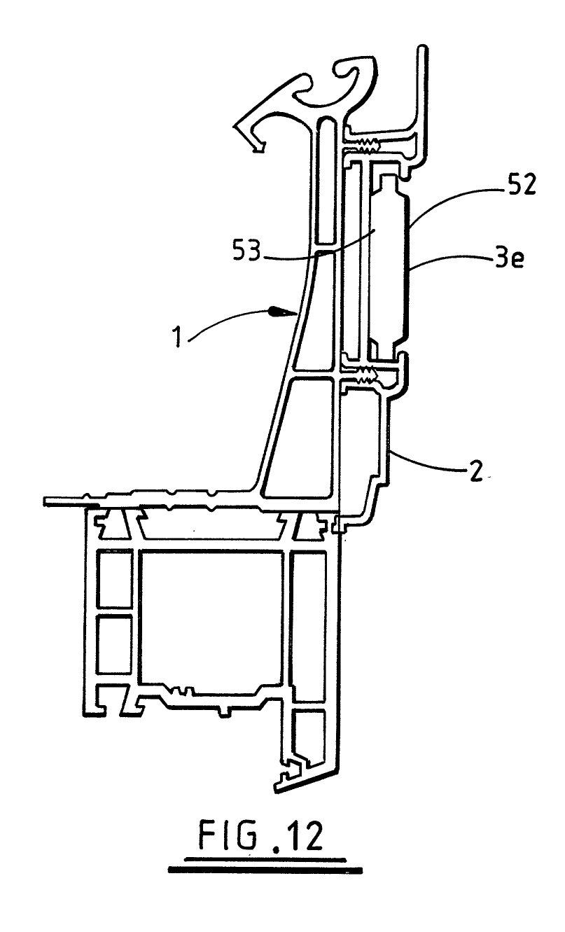

FIG. 12 is a side view of a sixth embodiment of a decorative covering member of the invention, in situ, attached to an eaves beam.

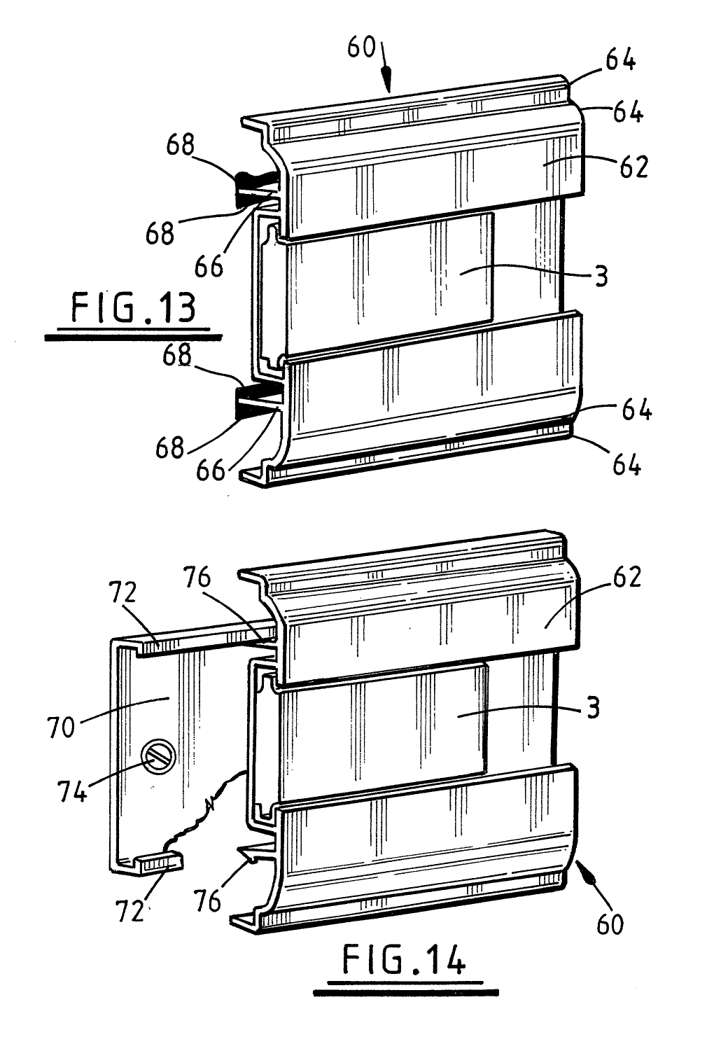

FIG. 13 is a perspective view of a still further preferred embodiment showing a plastics extrusion that enables the decorative strips of the invention to be incorporated in a dado rail.

FIG. 14 is a perspective view of a variation on FIG. 13 whereby a dado rail is affixed to a surface by being clipped to a backing member screwed to the surface.

Referring to FIGS. 1 and 5 of the accompanying drawings, a covering member for structural components of a conservatory comprises a fascia panel 2 having a decorative strip 3 retainable thereon, the fascia panel 2 being attachable to an eaves beam 1. The eaves beam 1 comprises fir-tree type ribs 4, which are push-fitted into longitudinally slotted formations 5 on the fascia panel 2, the formations having a series of raised bumps 6 on at least an inside face thereof, which serve to secure the covering member in place on the eaves beam 1. The decorative strip 3 has a top longitudinal edge 15 and a bottom longitudinal edge 16, with three-dimensional relief 17 thereon. However, it is envisaged that the decorative effects of the strip 3 are not limited to three-dimensional relief, and in fact can also comprise two-dimensional patterns alternatively or in addition to the three-dimensional relief 17.

As can be seen from FIGS. 1 and 5, the fascia panel 2 has a channel 7 therein, having sides 8 and 9 and base 10. The channel 7 is formed as a rebate in the fascia panel 2, and has top 11 and bottom 12 ribs extending from the sides of the channel towards each other. The top rib 11, along with at least a part of side 8, and base 10, forms a subsidiary channel 13, and the bottom rib 12, along with at least a part of side 9, and base 10, forms a subsidiary channel 14, the top subsidiary channel 13 being deeper than the bottom subsidiary channel 14 In order to releasably retain the decorative strip 3 in the channel 7 of the fascia panel 2, the top longitudinal edge 15 of the decorative strip 3 is first pushed up into the top subsidiary channel 13, allowing the bottom longitudinal edge 16 of the decorative strip 3 to be rotated into the bottom subsidiary channel 14, the bottom longitudinal edge 16 of the decorative strip 3 clearing the bottom rib 12. The decorative strip 3 is then dropped down into the bottom subsidiary channel 14, the top longitudinal edge 15 of the decorative strip 3 remaining within the top subsidiary channel 13, the vertical distance between the top 11 and bottom 12 ribs being less than the width A of the decorative strip 3.

Alternatively, the decorative strip 3 may simply be slotted into the channel 7 of the fascia panel 2 from the side.

The fascia panel 2 has a top front face 18 extending upwards from the side 8 of the main channel 7. When the covering member is in place on the eaves beam 1, the top front face 18 covers head 19 of the eaves beam 1. Further, fascia panel 2 has a bottom front face 20, which extends downwardly from the side 9 of the main channel 7. When the fascia panel 2 is in place on the eaves beam 1, the bottom front face 20 covers the bottom of the eaves beam 1. The bottom front face 20 is stepped and arcuate in nature.

The embodiment of the covering member shown in FIGS. 2 and 8 is the same as that shown in FIG. 1 in all aspects apart from the decorative strip 3a, which includes a raised edge 21 on each longitudinal edge 15 and 16 of the decorative strip 3a. In order to retain the decorative strip 3 on the fascia panel 2, the raised edges 21 of the decorative strip 3 are pushed past the top 11 and bottom 12 ribs of the fascia panel 2, thereby releasably holding the decorative strip 3a in the channel 7 of the fascia panel 2. FIG. 8 shows the eaves beam 1 and covering member in situ on a window frame 40.

In the aspect shown in FIG. 3 of the invention, the eaves beam 1a has two hooked members 22 and 23 thereon, which locate with a decorative strip 3b. The decorative strip 3b comprises a slot 24 in which the hooked member 23 locates, and a rebate 25 in which the hooked member 22 locates, thereby retaining the decorative strip 3b on the eaves beam 1a.

With reference to FIGS. 4 and 9, the fascia panel 2a is substantially planar, and the decorative strip 3c is profiled to have a channel 26 with depending sides 27 and 28. In order to retain the decorative strip 3c on the fascia panel 2a, the decorative strip 3c is snap-fitted past the plane 29 of the fascia panel 2a, thereby holding the decorative strip 3c in place. FIG. 9 shows the eaves beam 1 and covering member in situ on a window frame 40.

Referring to FIG. 6 of the drawings, the decorative profile is in the form of a cornice molding 3d, having three-dimensional relief 30 thereon. When in place, the cornice molding 3d conceals window blinds bottom rail 31 from view. The fascia panel 2b is the same as that shown in FIGS. 1, 2 and 5 of the drawings, being releasably attached to an eaves beam 1b. The fascia panel 2b has top 38 and bottom 39 ribs thereon. The cornice molding 3d has a channel 32 in the back face thereof, the channel having depending sides 32a and 32b. An attachment means 33 has two side members 34 and 35 connected by a web 36. The attachment means 33 locates, and is releasably held, within the channel 32 by means of the depending sides 32a and 32b of the channel. Each side member 34 and 35 has a raised edge 37 thereon, whereby in order to retain the cornice molding 3d on the fascia 2b, the raised edges 37 of the attachment means 33 are pushed past the top 38 and bottom 39 ribs of the fascia panel 2b, thereby releasably holding the cornice molding 3d on the eaves beam 1b.

As can be seen from FIG. 7, a typical conservatory comprises glazing bars 41, a ridge profile 42, eaves beams 43, window mullions 44 and corner posts 45. It is envisaged that the decorative strips or profiles of the invention may be applied to structural members of a conservatory such as these.

FIG. 10 shows a covering member comprising an attachment means 46, which is directly attachable to an eaves beam 1. The eaves beam 1 comprises fir-tree type ribs 4, which are push-fitted into longitudinally slotted formations 47 on the attachment means 46, the formations having a series of raised bumps 48 on at least an inside face thereof, which serve to secure the covering member in place on the eaves beam 1. The attachment means 46 also has legs 52 and 53 connected by web 54, the legs 52 and 53 being hooked at their extreme end, and the decorative strip 3c is profiled to have a channel 26 with depending sides 27 and 28. In order to retain the decorative strip 3c on the attachment means 46, the decorative strip 3c is snap-fitted over the hooked legs 52 and 53, thereby holding the decorative strip 3c in place. The attachment means 46 has means 49 for retaining a lighting unit 50, and means 51 for retaining a window blind bottom rail 31, thereon. When in situ, the decorative strip 3c conceals window blind bottom rail 31 and lighting unit 50 from view.

The embodiments of the covering member shown in FIGS. 11 and 12 are the same as those shown in FIG. 1, except for the decorative strip 3e, which is reversible in nature, having two profiled faces 52 and 53, whereby a user may reverse the strip 3e to expose the opposite profiled face, when required. FIG. 11 shows the eaves beam 1 and covering member in situ on a window frame 40.

Thus, the illustrated decorative covering member provides a neat, decorative and interchangeable finish to structural members, in that various colours and types of decorative strip may be retained on a fascia panel, a user having the option of choosing various colours and types of decorative strip or profile, which may be chosen to match or contrast with, for example, the furnishings in the conservatory. Furthermore, the user may easily change the decorative strip or profile if he or she purchases a different type or colour of furnishing for the conservatory, and can build up a selection of decorative strips or profiles to be used when required. It is envisaged that, when decorative covering members are applied to an eaves beam, for example, coordinating decorative covering members may be used, for example, along the cill of the window of the conservatory, or perhaps along the transom beam of the window. In this way, a user may co-ordinate the whole of his or her conservatory if desired.

FIG. 13 shows a dado rail generally referred to as 60 comprising a mounting component 62 which retains a decorative strip 3 in a similar fashion to that shown in FIGS. 1, 5, 11 and 12 of the accompanying drawings. The mounting component 62 has decoratively profiled features 64 to enhance the overall appearance of the dado rail 60. On the reverse side of the mounting component 62 are ribs 66 that enable the mounting component 62 to be affixed to a surface by means of adhesive beads 68.

FIG. 14 shows a variation of the dado rail 60 of FIG. 13 further comprising a backing component 70. The backing component 70 has resiliently deformable clips 72 and is affixed to a surface by means of screws 74. The reverse side of the mounting component 62 also has resiliently deformable clips 76 that are mutually engageable with the clips 72 of the backing component 70. To install the dado rail, the decorative strip 3, the mounting component 62 and the backing component 70 are each cut to a desired length. The backing component is fist screwed to the surface and the mounting component 62 is then clipped onto the backing component by mutually engaging the clips 72 and 76. Finally, the decorative strip 3 is inserted in the mounting component 62 to complete the effect.

1. A decorative strip attachable to conservatory or building components.

2. A decorative strip as claimed in claim 1, wherein the strip is attachable to internal or external conservatory components.

3. A decorative strip as claimed in claim 1 attachable to internal plastics components of a conservatory.

4. A decorative strip as claimed in claim 3 attachable to plastics conservatory components that cover aluminium structural members.

5. A decorative strip as claimed in claim 4, wherein the structural member of the conservatory is selected from eaves beams, windowsills, roof ridges, corner posts, mullions and window frame members.

6. A decorative strip as claimed in claim 5, wherein attachment thereof is to a plastics capping or fascia panel for an aluminium structural member.

7. A decorative strip as claimed in claim 1 further comprising means for securing the decorative strip to a surface.

8. A decorative strip as claimed in claim 7, wherein said securing means comprises a profiled extrusion that may be fastened to said surface.

9. A decorative strip as claimed in claim 1, wherein the strip is attachable to conservatory components or other building surfaces by means selected from adhesive, Velcro and magnetism.

10. A decorative strip as claimed in claim 1, wherein the strip is attachable to a surface by keyed attachment.

11. A decorative strip as claimed in claim 10, wherein said keyed attachment involves slots or rebates.

12. A decorative strip as claimed in claim 1, wherein a plastics component has a rebated channel formed thereon into which the decorative strip is slidable.

13. A decorative strip as claimed in claim 1, wherein a plastics component has a rebated channel formed therein having a top rebate deeper than a bottom rebate and the decorative strip or profile can be pushed up into the top rebate to clear the bottom rebate, so that it can drop into the bottom rebate.

14. A decorative strip as claimed in claim 1, wherein a plastics component and a decorative strip have mutually engageable formations, in order to retain the decorative strip on the plastics component.

15. A decorative strip as claimed in claim 14, wherein one of the plastics component and the decorative strip provides at least one hooked member and the other has a corresponding number of co-operating slots thereon, which locate over the hooked members, thereby releasably retaining the decorative strip or profile on the plastics component.

16. A decorative strip as claimed in claim 14, wherein the plastics component has at least one vertically spaced hooked member thereon, and the decorative strip has a corresponding number of co-operating slots thereon.

17. A decorative strip as claimed in claim 16, wherein the plastics component has two spaced hook members thereon.

18. A decorative strip as claimed in claim 1, wherein the decorative strip has a raised rim at or near each longitudinal edge thereof, whereby it may be retained on a plastics component by way of being snap-fitted past top and bottom ribs of the plastics component and held therein.

19. A decorative strip as claimed in claim 1, wherein the decorative strip is rebated to form a channel having edges allowing the decorative strip or profile to be snap-fitted over edges of a plastics component.

20. A decorative strip as claimed in claim 12, wherein the plastics component is a fascia panel or dado rail.

21. A decorative panel as claimed in claim 20, wherein, when the plastics component is a fascia panel, the means of attachment of the fascia to the structural member is by way of one or more fir-tree type ribs of one component push-fitted into slots of the other component.

22. A decorative panel as claimed in claim 21, wherein the ribs are on the structural member.

23. A decorative strip attached to a structural member of a conservatory.

24. A decorative strip as claimed in claim 23, wherein the structural member is an eaves beam having at least one vertically spaced hooked member thereon, and the decorative strip has a corresponding number of co-operating slots, whereby the decorative strip or profile is retained on the eaves beam.

25. A decorative strip as claimed in claim 24, wherein the eaves beam has two spaced hooked members thereon.

26. A decorative strip as claimed in claim 1 further comprising a mounting component.

27. A decorative strip as claimed in claim 26, wherein the mounting component is a plastics extrusion having formations thereon for retaining the decorative strip.

28. A decorative strip as claimed in claim 27, wherein the mounting component has on its reverse side features suitable for gluing the mounting component to a surface of a building.

29. A decorative strip as claimed in claim 28, wherein said features are webs.

30. A decorative strip as claimed in claim 27, wherein resiliently deformable clips are provided on the reverse side of the mounting component that engage with resiliently deformable clips of a further backing component.

31. A decorative component as claimed in claim 1, wherein the decorative strip has three-dimensional relief thereon.

32. A decorative strip as claimed in claim 1 made from plastics, wood or fabric.

33. A decorative strip as claimed in claim 1, wherein the decorative strip is injection moulded.

34. A decorative strip as claimed in claim 1 shaped and sized in order to accommodate other items to be at least partially concealed thereby.

35. A decorative strip as claimed in claim 34, wherein the decorative strip is in the form of a cornice molding that can extend upwardly and inwardly from an eaves beam to provide space for concealing window blinds or lighting components.

36. A decorative strip as claimed in claim 1, wherein the decorative strip is reversible in nature, having different decorative effects on opposing faces thereof.

37. A conservatory decorated with decorative strips according to claim 1.
